(19) United States
(12) Patent Application Publication
(10) Pub. No.: US 2004/0218995 A1
(43) Pub. Date: Nov. 4, 2004

(54) Finishing buffer

(75) Inventor: William T. Graushar, Elm Grove, WI (US)

Correspondence Address: MICHAEL BEST & FRIEDRICH, LLP, 100 E WISCONSIN AVENUE, MILWAUKEE, WI, 53202, US

(73) Assignee: Quad/Graphics, Inc., Sussex, WI

(21) Appl. No.: 10/837,097

(22) Filed: Apr. 30, 2004

Related U.S. Application Data
(60) Provisional application No. 60/466,821, filed on Apr. 30, 2003.

(51) Int. Cl. B42C 1/00

(52) U.S. Cl. 412/1

(57) ABSTRACT

A finishing line including at least one buffer operable to receive printed products and deliver the printed products to the same or different finishing line. The buffer allows the finishing process to continue operating while one section of the finishing line is being repaired.

### RELATED APPLICATIONS

This application claims priority to U.S. Provisional Patent Application No. 60/466,821, filed Apr. 30, 2003. The contents of Application No. 60/466,821 are hereby incorporated by reference.

### BACKGROUND OF THE INVENTION

In a typical printed product finishing process, which can include both perfect binding and saddle stitching for example, often times when a fault happens, such as in the gatherer, binder or the trimmer, it typically takes just a few seconds to get the fault cleared and the finishing line back up and running. However, those seconds can add up to minutes which translates into lost efficiency in time and money. During the time the fault is being repaired, the entire finishing process is stopped until the fault is cleared.

### BRIEF DESCRIPTION OF THE INVENTION

The invention relates to using a buffer or multiple buffers in a printed product finishing process.

The invention relates to the use of one or more buffers in a printed product finishing process. With the use of a buffer inline in the finishing process, should there be a fault, other portions of the finishing line continue to run while the fault is being repaired. Therefore, the reduction of efficiency during the fault condition is minimized. The use of one or more buffers in the finishing process enables the process to run more continuously and to run more efficiently.

### BRIEF DESCRIPTION OF THE DRAWINGS

FIG. 1 is a schematic plan view of a finishing process including a buffer positioned between a binder and a trimmer.

FIG. 2 is a schematic plan view of a finishing process including a buffer positioned between a trimmer and end-of-line processing equipment.

FIG. 3 is a schematic plan view of a finishing process including multiple buffers.

FIG. 4 is a schematic plan view of two finishing lines including a buffer positioned between the lines.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

FIG. 1 schematically illustrates a finishing line in the form of a printed product binding line 10 such as a book/magazine binding process. The printed products can be signatures, single sheets, bound books such as, magazines, catalogs, direct mail pieces, and the like. The finishing process usable with the embodiments of the present invention may include binding lines such as, either perfect binding or saddle stitching and all other types of finishing lines, such as, for example, mailing lines, wrapping lines, and packaging lines. The exemplary binding line 10 includes a gatherer 12, binder 14, trimmer 16 and end-of-line processing equipment 18. It should be noted that additional equipment may be used on the binding process as well as alternative configurations. The specifics of the equipment used and its configuration on the binding line 10 can vary while still employing the present invention.

To increase the efficiency of the binding process, at least one buffer is used. According to one embodiment of the invention, FIG. 1 illustrates a buffer 20 positioned between the binder 14 and the trimmer 16. The capacity (e.g., the number of holding slots) of the buffer can vary depending on the size of the buffer. A variety of available buffers can be utilized. For example, one buffer particularly suited for this application is model A-393 available from Sitma Corporation. However, it should be noted that other buffers can be used with the present invention.

The buffer 20, positioned between the binder 14 and the trimmer 16, enables the gatherer 12 and the binder 14 of the binding process to continue running, at least for the time it takes to fill the buffer 20, if the trimmer 16 has a fault and stops running. Conversely, if the gatherer 12 or binder 14 has a fault and ceases operating, the trimmer 16 continues running, at least until the buffer 20 is emptied.

In one embodiment of the invention, the buffer 20 can be modular or portable, meaning that it can be moved from a first location to a second location. For example, such a buffer 20 could be strategically positioned depending on the binding job. If the trimmer 16 were faulting more than the gatherer 12 or binder 14, the buffer 20 would typically be filled to its minimum capacity. Therefore, when the trimmer 16 faulted, the buffer 20 would be able to accept product from the gatherer 12 and binder 14. If the gathering or binder sections 12 and 14 were faulting more than the trimmer 16, the buffer 20 would typically be filled near its maximum capacity. Therefore, when the gatherer 12 or binder 14 faulted, the buffer 20 would be able to continue to deliver product to the trimmer 16.

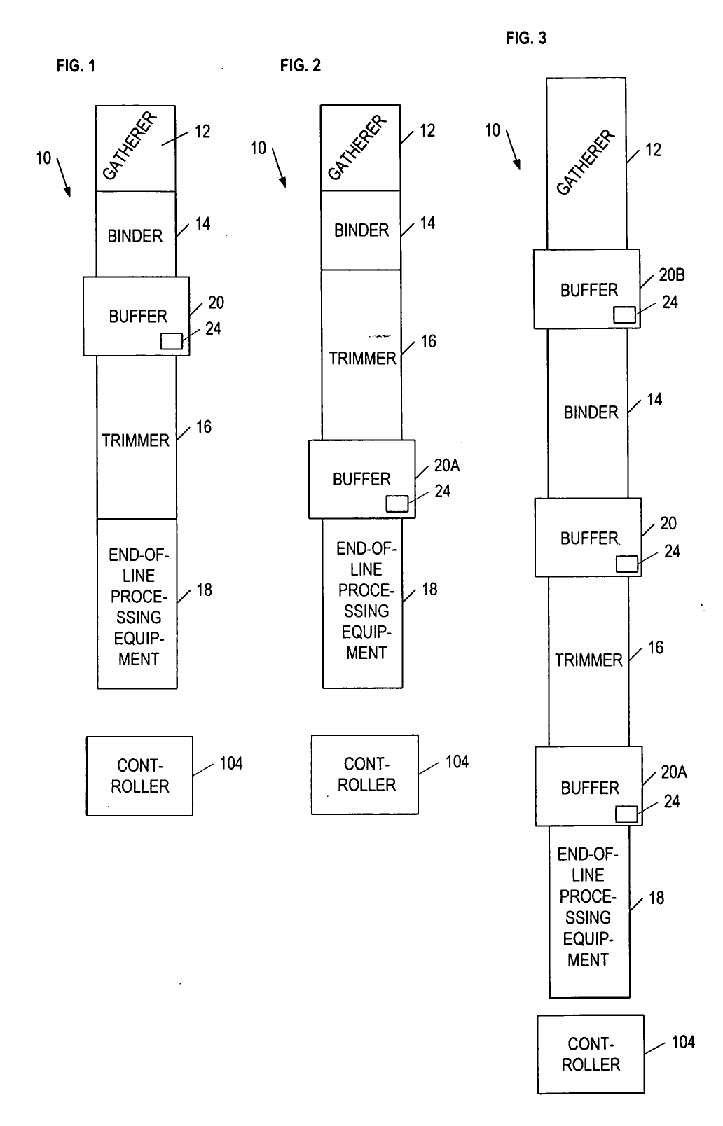

The invention contemplates other strategic locations for positioning a buffer or buffers. For example, and with reference to FIG. 2, a buffer 20A can be positioned between the trimmer 16 and the end-of-line processing equipment 18. In this arrangement, the binding process would continue despite end-of-line equipment problems such as with stackers, strappers, sorters, and the like. Other buffer positions can include a position between the gatherer 12 and the binder 14. A buffer 20 can also be located at any choke or transition point along the binding line 10. For example, the invention contemplates the use of a buffer or multiple buffers within the gatherer 12 to enable the gatherer to run when faults occur therein. The invention contemplates the use of a buffer between the gatherer 12 and binder 14 to enable that equipment to run when faults occur therein.

With reference to FIG. 3, multiple buffers 20, 20A and 20B can be used on the same binding line 10 to further increase efficiency of the binding line 10. As shown, a buffer 20B is positioned between the gatherer 12 and binder 14, a buffer 20 is positioned between the binder 14 and trimmer 16, and a buffer 20A is positioned between the trimmer 16 and end-of-line processing equipment 18. It should be noted that more or less buffers 20 could be used as well as in different positions on the binding line 10. In addition, multiple buffers can be positioned adjacent to one another to provide a larger holding capacity for the products. For example, a product can enter a first buffer, exit the first buffer, and then immediately enter a second buffer.

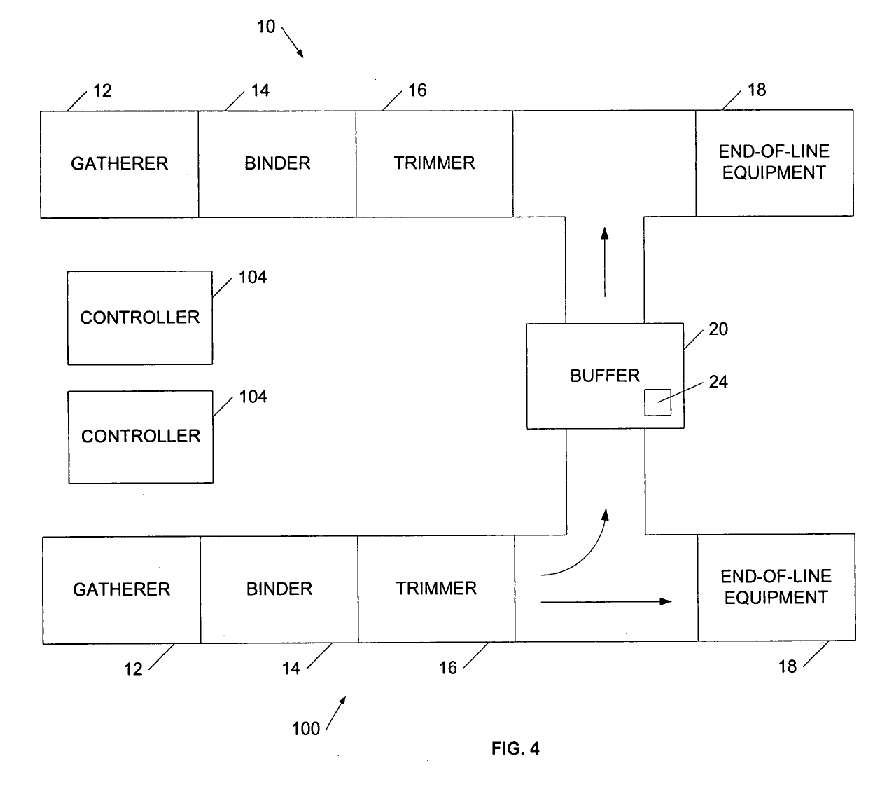

FIG. 4 illustrates a buffer 20 positioned between a first binding line 10 and a second binding line 100 according to one embodiment of the invention. The buffer 20 can be positioned at any location along the binding lines 10 and 100. In addition, the buffer 20 can be positioned at different locations on each binding line 10 and 100. For example, the buffer 20 can be positioned after the trimmer 16 on the binding line 10 and after the binder 14 on the binding line 100. The buffer 20 can receive products from the first binding line 10 and can feed the products onto the second binding line 100. Each of the binding lines 10 and 100 can include a controller 104. Each of the controllers 104 maintains a product order, mailing list, or sequence list (collectively referred to as “mailing list”) for each binding line 10 and 100. One of the controllers 104 can merge the two mailing lists into one master mailing list. The products on the second binding line 100 can be positioned in a buffer 20 and be selectively fed from the buffer 20 into the proper location on the first binding line 10 according to the mailing sequence. All of the products are not required to enter the buffer 20. Rather, some of the products on the second binding line 100 can continue along the binding line 100. It should be noted that the products on each of the binding lines 10 and 100 can be of the same type, e.g., the products on the first and second binding lines 10 and 100 are magazines, for example, or different types, e.g., the products on the first binding line 10 are magazines, for example, and the products on the second binding line 100 are not magazines. It should also be noted that various classes of mail can be combined and merged into one mailing list.

To further improve the efficiency of the finishing process, various sections of the binding lines 10 and 100 can operate at different speeds from one another. In one example, the trimmer 16 and the gatherer 12 and/or binder 14 could be run at different speeds. If there are more problematic issues in the trimmer 16, the trimmer 16 would have the ability to run faster than the gatherer 12, thereby keeping the buffer 20 in a near empty state. In this way, when the trimmer 16 faults, the gatherer 12 could continue to run, putting product into the buffer 20. After the trimmer 16 fault is corrected and the buffer 20 had gained product volume, the trimmer 16 would temporarily run faster than the gatherer 12 until the buffer 20 was again near minimum capacity. Conversely, if there were more problematic issues in the gatherer 12, the opposite logic would apply. The gatherer 12 at times would run faster than the trimmer 16, keeping the buffer 20 filled near capacity so the trimmer 16 could run while faults were attended to in the gatherer 12.

The buffer 20 can include a sensor 24 as shown in FIGS. 1-4 that is operable to determine the height of the products in the buffer 20. Based on the amount of the products, the sensor 24 can communicate with the controller 104 to modify the speed of the section of the binding lines 10 and/or 100 to move faster or slower.

Various features and advantages of the invention are set forth in the following claims.

What is claimed is:

1. A method of positioning a buffer in a printed product finishing line, the method comprising:
identifying which section of a finishing line processing printed products operates with more faults; and
positioning a buffer in-line, adjacent to and downstream of the identified section.

2. A method of processing printed products, the method comprising:
positioning a buffer in a finishing line; and
continuing to process printed products on the finishing line using the buffer while one section of the finishing line is being repaired.

3. A method of processing printed products, the method comprising:
positioning a buffer between an upstream section of a finishing line and a downstream section of the finishing line; and
continuing to process printed products from the buffer in the downstream section of the finishing line when a fault occurs in the upstream section of the finishing line.

4. A method of processing printed products, the method comprising:
positioning a buffer between an upstream section of a finishing line and a downstream section of the finishing line; and
continuing to process printed products in the upstream section of the finishing line by placing the printed products in the buffer should a fault occur in the downstream section.

5. A method of combining two mail streams, the method comprising:
generating a first mailing list for a first mail stream on a first finishing line;
generating a second mailing list for a second mail stream on a second finishing line;
combining the first and second mailing lists to generate a master mailing list;
moving products in the first mail stream to a buffer; and
merging the products in the buffer into the second mail stream.

6. A method of controlling a finishing line, the method comprising:
positioning a buffer in the finishing line;
moving products into the buffer;
sensing an amount of the products on the buffer; and
based on the amount, communicating with a controller to adjust the speed of a section of the finishing line.

7. A method of processing printed products, the method comprising;
positioning a buffer between a binder section of a binding line and a trimmer section of the binding line;
moving printed products into the buffer;
processing printed products from the buffer at the trimmer section when a fault occurs in the binder section of the binding line; and
processing printed products at the binder section by continuing to move printed products into the buffer when a fault occurs in the trimmer section of the binding line.

8. A method of processing printed products, the method comprising:
positioning a buffer between a trimmer section of a binding line and an end-of-line equipment section of the binding line;
moving printed products into the buffer;
processing printed products from the buffer at the end-of-line section when a fault occurs in the trimmer section of the binding line; and
processing printed products at the trimmer section by continuing to move printed products into the buffer when a fault occurs in the end-of-line section of the binding line.

9. A method of processing printed products, the method comprising:
positioning a first buffer between a first section of a binding line and a second section of the binding line;
positioning a second buffer in the binding line;
moving printed products into the first buffer and the second buffer;
processing printed products from one of the first buffer and the second buffer at the second section when a fault occurs in the second section of the binding line; and
processing printed products at the first section by continuing to move printed products into one of the first buffer and the second buffer when a fault occurs in the second section of the binding line.

10. A method of processing printed products, the method comprising:
positioning a buffer between a first section and a second section of a finishing line;
operating the first section and the second section of the finishing line in a non-fault state; and
adjusting a speed of one of the first section and the second section when the finishing line is in a fault state.

11. A method of processing printed products, the method comprising:
positioning a buffer between a first section and a second section of a finishing line;
adjusting a speed of the second section to be faster than the first section to keep the buffer in a near-empty state; and
processing printed products in the first section by continuing to move printed products into the buffer when a fault occurs in the second section.

12. A method of processing printed products, the method comprising:
positioning a buffer between a first section and a second section of a finishing line;
adjusting a speed of the first section to be faster than the second section to keep the buffer in a near-full state; and
processing printed products from the buffer in the second section when a fault occurs in the first section.
